(19) United States
(12) Patent Application Publication
(10) Pub. No.: US 2026/0003654 A1
(43) Pub. Date: Jan. 1, 2026

(54) Apparatuses, Devices, Methods, Non-Transitory Computer-Readable Media, and Computer System for a First and a Second Virtual Machine

(71) Applicant: Intel Corporation, Santa Clara, CA (US)

(72) Inventors: Bing DENG, Shanghai (CN); Yu WANG, Beijing (CN); Xiaocheng MAO, Shanghai (CN); Junjie MAO, Shanghai (CN); Luhai CHEN, Shanghai (CN); Ziniu LIN, Shanghai (CN); Hongyu ZHANG, Shanghai 31 (CN); Tao XU, Shanghai (CN); Fei JIANG, Shanghai (CN); Yue HE, Shanghai (CN); Kai LIU, Shanghai (CN); Chao XIE, Shanghai (CN)

(21) Appl. No.: 19/318,468

(22) Filed: Sep. 4, 2025

(30) Foreign Application Priority Data
Sep. 13, 2024 (WO) PCT/CN2024/118855

(51) Int. Cl. G06F 9/455; G06F 9/451; G06F 9/54

(52) U.S. Cl. CPC G06F 9/45545; G06F 9/451; G06F 9/544

(57) ABSTRACT

Various examples relate to apparatuses, devices, methods, non-transitory computer-readable media and computer system for a first and a second virtual machine. A non-transitory computer-readable medium storing instructions that, when executed by one or more processing circuitries, cause the one or more processing circuitries to perform a method for a first virtual machine, with the method comprising executing an application, providing a virtual screen for a graphics output of the application, providing the graphics output provided to the virtual screen to a second virtual machine via an inter-virtual machine shared memory mechanism.

### BACKGROUND

Modern vehicles increasingly employ multiple screens, including dashboard displays, middle console screens, copilot displays, and rear seat entertainment systems. These screens are often powered by a central computing system that utilizes virtual machines (VMs) to manage different applications and services. The central computer runs multiple VMs simultaneously, with each VM dedicated to specific functions such as navigation, entertainment, vehicle diagnostics, or climate control. Through screencasting technology, the content generated by these VMs is projected to the respective screens throughout the vehicle, while the main dashboard display may connect directly to the central system for critical driving information.

This VM-based architecture offers several advantages: it provides strong isolation between different vehicle systems for enhanced security, enables independent updates of different functions, and allows for resource optimization across the computing environment. If one system experiences issues, others can continue to function normally. The screencasting approach also simplifies wiring and hardware requirements, as the displays themselves need minimal processing capabilities, functioning primarily as receivers for content generated by the central computing system's VMs.

Screencasting between the operating systems of the central computer and the displays is usually implemented using a network. In the following, four network-based screencasting platforms are discussed. DLNA (Digital Living Network Alliance) is a set of interoperability standards for sharing home digital media among multimedia devices. It allows users to share or stream stored media files to various certified devices on the same network, such as PCs, smartphones, TV sets, game consoles, stereo systems, and NASs. Wi-Fi CERTIFIED Miracast™ enables seamless display of multimedia content between Miracast® devices. Miracast allows users to wirelessly share multimedia, including high-resolution pictures and high-definition (HD) video content, between Wi-Fi devices, even if a Wi-Fi network is not available. Android Scrcpy is another approach to screencasting. This application mirrors Android devices (video and audio) connected via USB or over TCP/IP and allows users to control the device with the keyboard and the mouse of the computer. It does not require any root access and works on Linux, Windows, and macOS. Apple® (a trademark of Apple Inc.) AirPlay® enables users to share videos, photos, music, and more from Apple devices to screens or audio devices.

### BRIEF DESCRIPTION OF THE FIGURES

Some examples of apparatuses and/or methods will be described in the following by way of example only, and with reference to the accompanying figures, in which:

FIG. 1 shows a schematic diagram of screens and computing devices used in a vehicle;

FIG. 2 shows a feature comparison between existing screencast technologies and the proposed concept;

FIG. 3a shows a schematic diagram of a computer system with at least one apparatus or device;

FIG. 3b shows flow charts of examples of methods for a first and a second virtual machine;

FIG. 4 shows a detailed example of a computer system with two virtual machines;

FIG. 5 shows an input event flow, a data flow of a display over virtual shared memory, and a data flow of dGPU rendering;

FIG. 6 shows a block diagram of an electronic apparatus;

FIG. 7 illustrates a computing device; and

FIG. 8 shows an example of a higher-level device application.

### DETAILED DESCRIPTION

Some examples are now described in more detail with reference to the enclosed figures.

However, other possible examples are not limited to the features of these examples described in detail. Other examples may include modifications of the features, as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for the sake of clarification.

When two elements A and B are combined using an “or”, this is to be understood as disclosing all possible combinations, i.e., only A, only B, as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an”, or “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise”, and/or “comprising”, when used, describe the presence of the specified features, integers, steps, operations, processes, elements, components, and/or a group thereof, but do not exclude the presence or addition of one or more other features, integers, steps, operations, processes, elements, components, and/or a group thereof.

Unless otherwise defined, all terms (including technical and scientific terms) are used herein in their ordinary meaning in the art to which they belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. These adjectives do not imply that the element so described must be in a given sequence, either temporally or spatially, in ranking, or any other manner. “Connected” may indicate that elements are in direct physical or electrical contact with each other, and “coupled” may indicate that elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

Various examples of the present disclosure relate to a lossless video quality screencast mechanism among virtual machines. The proposed concept uses a shared buffer that is shared among multiple virtual machine (VM) instances for the purpose of display streaming.

With the increasing computational power of physical platforms, along with factors such as cost reduction, alleviation of supply chain pressures, and ease of load deployment, approaches involving workload consolidation through virtualization technology are becoming increasingly prevalent in automotive systems.

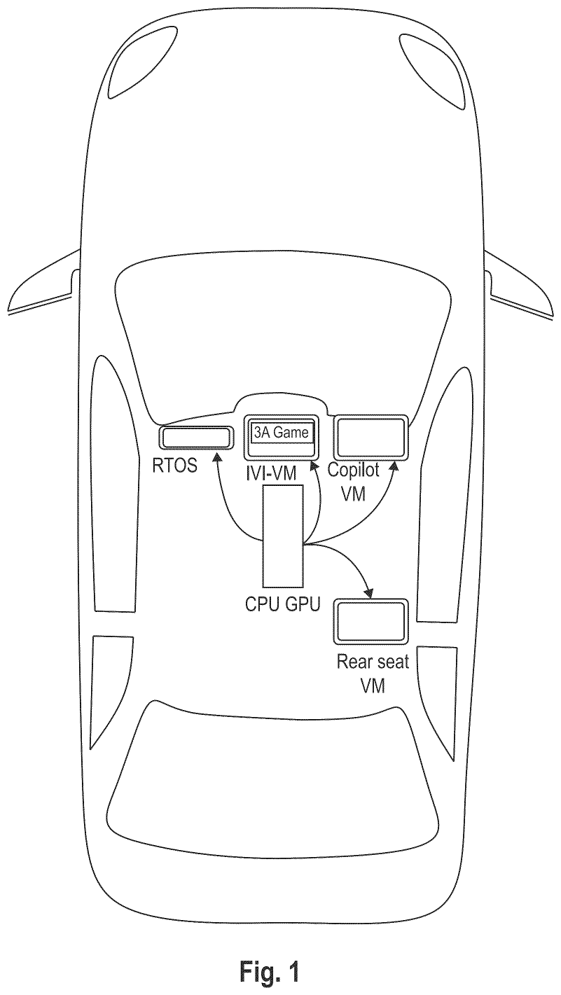

FIG. 1 shows a schematic diagram of screens and computing devices used in a vehicle. As shown in FIG. 1, the four screens in the vehicle are implemented by four independent virtual machines, such as the RTOS (Real-Time Operating System) for the instrument cluster, the Android IVI-VM (In-Vehicle Infotainment VM) for the front seat IVI, and two Android VMs for the rear seat entertainment screens.

Gaming in vehicles has become a significant differentiating feature. Except for the instrument cluster screen, all other three entertainment screens benefit from gaming support. This evolution benefits from a concept that is capable of accommodating multiple virtual machines and screens. Gaming has high demands on GPU (Graphics Computing Unit) computing power, which can be satisfied by a discrete GPU (dGPU, in contrast to an integrated GPU, iGPU). Sharing the discrete GPU over software virtualization to the different entertainment VMs introduces a significant virtualization overhead, which may result in a 30-50% performance downgrade for the use of the dGPU and which may thus significantly reduce the FPS (frames per second) for triple A games, adversely affecting the user experience. Therefore, screencasting may be used to pass through the discrete GPU to a designated VM, such as the IVI-VM, allowing the IVI-VM to have almost zero overhead GPU performance, which leads to an optimal game performance when run locally on IVI-VM. Screencasting technology is then utilized to cast the IVI-VM to another VM, such as a copilot VM or a rear seat-VM to address rear-seat entertainment needs. Existing screencast solutions may not provide a user experience that is similar to locally executed games and applications, as they are network stream-based solutions that result in worse video quality, introduced by the video encoder/decoder, long latency introduced by the network itself, and extra system overhead including network bandwidth, CPU (Central Processing Unit), GPU, etc.

Screencast technology primarily originates from the cloud computing domain and is usually based on networks, such as DLNA, Wi-Fi CERTIFIED Miracast™, Android Scrcpy, and

Apple AirPlay. It may suffer from challenges, including reduced video quality, the necessity of consuming network bandwidth, and significant network latency. Some of these challenges are not mitigated even in local environments across virtual machines (VMs), for example, the degradation of video quality. Moreover, on limited hardware resources, screencasting incurs an additional system overhead, such as CPU (Central Processing Unit) and memory costs introduced by virtualized networks, as well as cache pollution.

To improve the situation, several challenges may be addressed, such as (1) video image quality degradation, (2) latency, (3) system overhead, (4) application compatibility, and/or (5) hardware platform compatibility. These challenges are particularly relevant in a virtualization environment with multiple guest Virtual Machines (VMs). In the proposed concept, the first three challenges are addressed through a shared memory-based inter-VM mechanism, a common feature in most hypervisor solutions. The fourth and fifth challenges can be addressed using the existing network streaming-based screencast mechanism. However, this can compromise the first three challenges, as the existing network stack introduces memory copy overhead several times over. This, in turn, may lead to the use of video encode/decode mechanisms to mitigate the memory copy overhead and latency, ultimately impacting video quality.

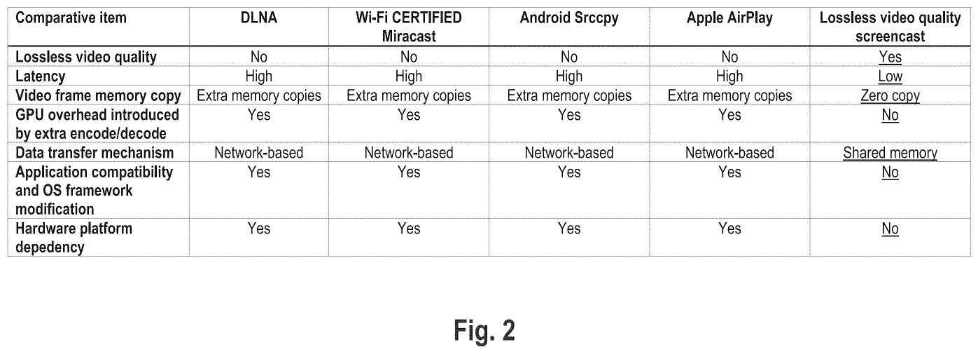

The proposed concept addresses the limitations described above, satisfying the challenges. FIG. 2 shows a feature comparison between existing screencast technologies and the proposed concept. The proposed concept uses an inter-VM shared memory mechanism that allows the screencast receiver to provide a virtualized display device to the sender. From the sender's perspective, this is no different from a bare metal GPU device. As a result, the existing graphic stack can be leveraged directly, ensuring seamless compatibility with the application ecosystem. The proposed concept does not depend on specific hardware features and can be easily ported to any hypervisor framework, as long as the bottom transport layer is implemented by the shared memory interfaces implemented by the target hypervisor. The proposed concept may further support screencasting a single video source to multiple VMs.

Sharing memory between virtual machines (VMs) is a common technique. Virtual CPUs (vCPUs) have also been supported on vhost-user (a protocol that enables the separation of the virtual switch datapath from the virtual machine monitor (VMM), allowing virtual network interfaces to be implemented as user space processes that communicate with the virtual switch through shared memory), but security issues caused by shared memory, along with the requirement that all interrupts must pass through the host machine, may lead to unstable vertical blanks (vblank), which can affect the FPS (Frames Per Second) stability in gaming.

The proposed concept uses a combination of screencasting, shared memory, and virtual CPUs (vCPUs) to address the challenges of screencasting. Through the proposed concept, a series of user pain points caused by the sharing of discrete GPUs (dGPUs), such as significant virtualization losses in triple A games and security isolation issues, are addressed. At the same time, the proposed concept provides additional benefits, such as compatibility and hardware platform independence.

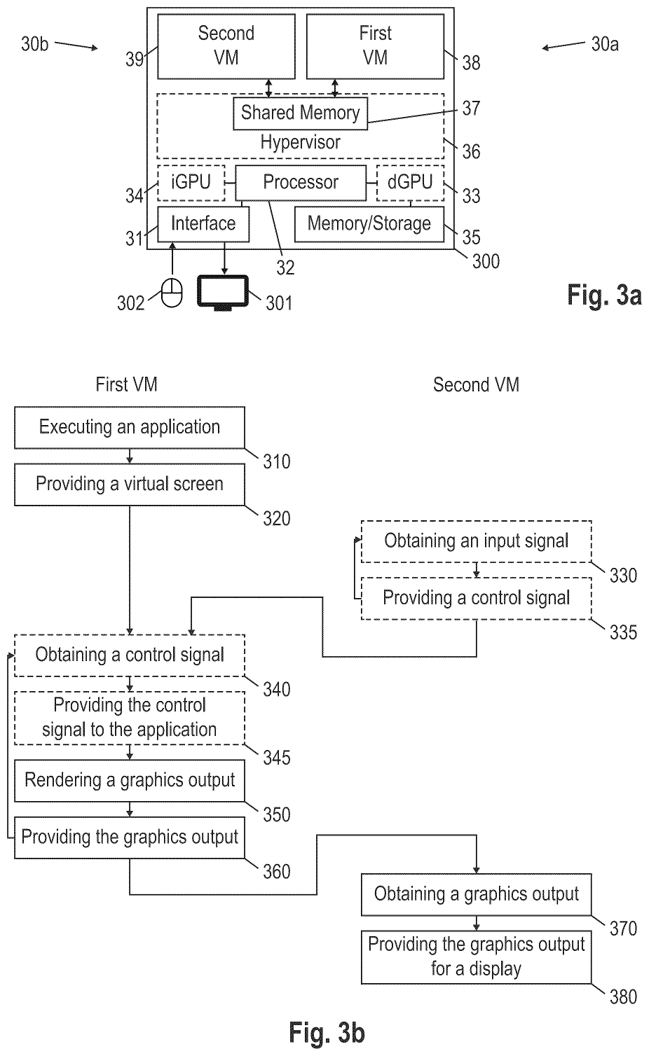

FIG. 3a shows a schematic diagram of a computer system 300 with at least one apparatus (e.g., a first apparatus 30a for a first virtual machine 38 and a second apparatus 30b for a second virtual machine 39) or at least one device 30 (e.g., a first device 30 for the first virtual machine 38 and a second device 30b for the second virtual machine 39). In general, the apparatuses 30a, 30b or devices 30a, 30b (mostly) share the same hardware components-they differentiate themselves from each other by hosting the first virtual machine 38 vs. hosting the second virtual machine 39. For example, apparatuses 30a, 30b comprise circuitry to provide the functionality of the respective apparatus 30a, 30b. For example, the circuitry of the apparatus 30a, 30b may be configured to provide the functionality of the apparatus 30. For example, the apparatuses 30a, 30b may share interface circuitry 31, processing circuitry 32, and/or memory storage circuitry 35. dGPU circuitry 33 may be used exclusively by the apparatus 30a for hosting the first virtual machine 38, while the iGPU circuitry 34 may be used by the apparatus 30b for hosting the second virtual machine 39 or by both apparatuses 30a, 30b. The processing circuitry 32 is coupled with the interface circuitry 31, the dGPU circuitry 33, the iGPU circuitry 34, and the memory/storage circuitry 35. For example, the processing circuitry 32 may provide the functionality of the respective apparatus 30a, 30b, in conjunction with the interface circuitry 31 (for communicating with other entities inside or outside the computer system 300), the memory/storage circuitry 35 (for storing information, such as machine-readable instructions), the discrete GPU circuitry 33 (in case of the apparatus 30a for the first VM 38), and/or the integrated GPU 34. Likewise, the devices 30a, 30b may comprise means for providing the functionality of the respective device 30a, 30b. For example, the means may be configured to provide the functionality of the respective device 30a, 30b. The components of the devices 30a, 30b are defined as component means, which may correspond to, or be implemented by, the respective structural components of the apparatuses 30a, 30b. For example, the devices 30a, 30b of FIG. 3a comprise means for processing 32, which may correspond to or be implemented by the processing circuitry 32, means for communicating 31, which may correspond to or be implemented by the interface circuitry 31, (optional) means for storing information 35, which may correspond to or be implemented by the memory or storage circuitry 35, a discrete GPU 33, which may correspond to or be implemented by the dGPU circuitry 33, and an integrated GPU, which may correspond to or be implemented by the iGPU circuitry 34. In general, the functionality of the processing circuitry 32 or means for processing 32 may be implemented by the processing circuitry 32 or means for processing 32 executing machine-readable instructions. Accordingly, any feature ascribed to the processing circuitry 32 or means for processing 32 may be defined by one or more instructions of a plurality of machine-readable instructions. The apparatuses 30a, 30b or devices 30a, 30b may comprise the machine-readable instructions, e.g., within the memory or storage circuitry 35 or means for storing information 35. For example, the computer system 300 may be an in-vehicle computer system. For example, the vehicle may comprise the computer system 300.

In the case of the apparatus 30a for the first VM 38, the processing circuitry 32 or means for processing 32 is to execute an application, provide a virtual screen for a graphics output of the application, and provide the graphics output provided to the virtual screen to the second virtual machine 39 via an inter-virtual machine shared memory mechanism 37. In the case of the apparatus 30b for the second VM 39, the processing circuitry 32 or means for processing 32 is to obtain the graphics output of the application being executed by the first virtual machine via the inter-virtual machine shared memory mechanism 37, and output the graphics output to a display 301 associated with the second virtual machine.

FIG. 3a shows flow charts of examples of corresponding methods for a first and a second virtual machine. The method for the first virtual machine comprises executing 310 the application, providing 320 the virtual screen for the graphics output of the application, and providing 360 the graphics output provided to the virtual screen to the second virtual machine via an inter-virtual machine shared memory mechanism. The method for the second virtual machine comprises obtaining 370 the graphics output of the application being executed by the first virtual machine via the inter-virtual machine shared memory mechanism, and outputting 380 the graphics output to the display associated with the second virtual machine.

In the following, the features of the computer system 300, the apparatuses 30a, 30b, or devices 30a, 30b, and of the methods of FIG. 3b (and of one or more corresponding computer programs) will be discussed in more detail with reference to computer system 300 and apparatuses 30a, 30b. Features discussed in connection with computer system 300 and apparatuses 30a, 30b may likewise be included in the corresponding devices 30a, 30b, methods of FIG. 3b, and in one or more corresponding computer programs.

As shown in FIG. 3a, the VMs use the respective hardware components of the computer system 300 (and thus the respective apparatuses 30a, 30b) via a hypervisor 36. A hypervisor 36 is a software layer that creates, manages, and runs virtual machines. It abstracts the physical hardware resources of the computer system 300 and enables multiple operating systems to run concurrently on the same physical machine. The hypervisor 36 can be classified as Type 1 (bare-metal), which runs directly on the hardware, or Type 2, which runs on top of a host operating system.

The virtual machines 38, 39 access the hardware of computer system 300 through the hypervisor 36, which acts as an intermediary. The hypervisor 36 presents virtualized hardware interfaces to the VMs and manages the allocation of physical resources such as CPU, memory, storage, and network devices. When a VM needs to perform hardware operations, it makes requests to the hypervisor 36, which then translates these requests into actual hardware operations on the physical components of computer system 300.

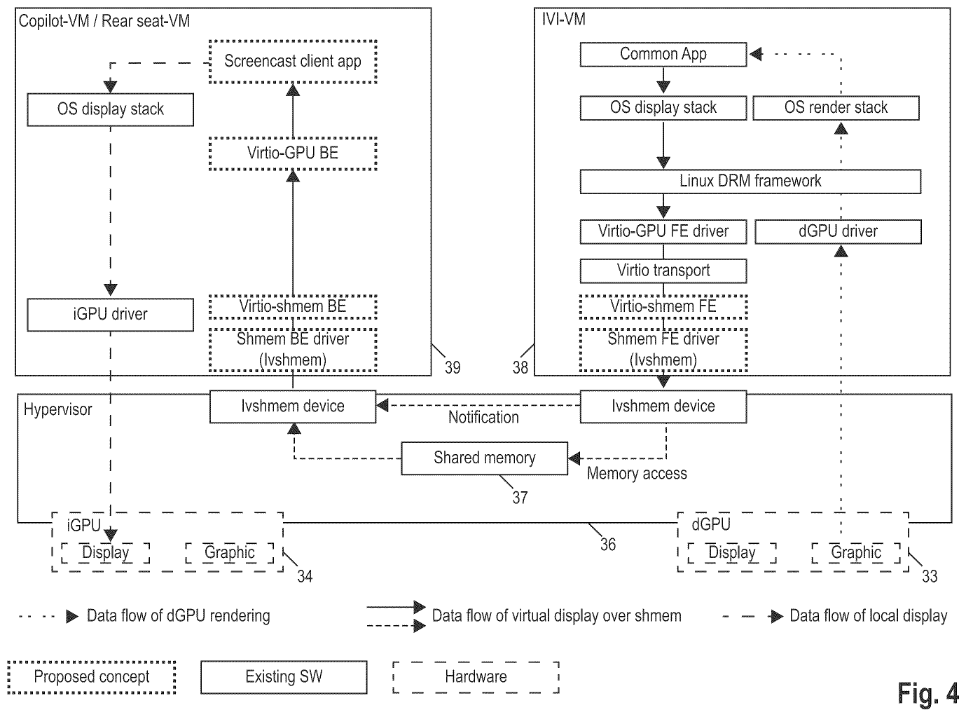

The proposed concept uses shared memory 37, provided by the hypervisor 36, to communicate, and in particular to provide the graphics output from the first VM 38 to the second VM 39. Communication between VMs via shared memory 37 is an efficient mechanism provided by the hypervisor 36. The hypervisor 36 allocates a region of physical memory as shared memory 37 that multiple VMs can access. To establish this communication channel, the hypervisor 36 maps the same physical memory pages into the address spaces of participating VMs. This shared memory 37 allows VMs to exchange data directly without the overhead of traditional network protocols or the involvement of the hypervisor 36 in each data transfer operation. The shared memory 37 communication process typically involves synchronization mechanisms to coordinate access between VMs. When a VM writes data to shared memory 37, it may signal completion through an interrupt or notification mechanism (see FIG. 4) managed by the hypervisor 36. The receiving VM (the second VM 39 in the case of the display output) can then read the data from shared memory 37. This approach significantly reduces communication latency compared to emulated network interfaces since it eliminates the need for data to travel through multiple software layers of computer system 300. Thus, the graphics output may be provided to a shared memory device 37 provided by the hypervisor 36 of the computer system 300 hosting the first virtual machine 38 and the second virtual machine 39.

The proposed concept is based on providing a virtual screen for the graphics output of the application (which may be executed inside a container within the first virtual machine). This virtual screen exists only in software; it is not connected to the first virtual machine 39 or the computer system 300. In various examples of the proposed concept, e.g., if the first virtual machine is a Linux-based virtual machine, the virtual display may be provided by a virtio (a standardized interface for virtual devices in virtualization environments that enables efficient communication between guest operating systems and hypervisors, improving performance by reducing virtualization overhead)-based graphics processing unit driver executed by the first virtual machine. A virtio-based GPU driver can provide a virtual screen by implementing the virtio-gpu protocol, which allows a guest operating system to render graphics that are then displayed by the host, or, in the present case, the first VM to render graphics that are then provided to the second VM. The driver creates a virtual display adapter that exposes framebuffer memory to the first virtual machine, and ultimately to the application. When the first virtual machine 38 renders to this framebuffer, the driver transfers the rendered content to the second VM through virtio transport mechanisms. The second VM 38 then receives the content (i.e., the graphics output), and outputs it via the display 301. In the proposed concept, the transmission between the driver on the side of the first virtual machine (denoted virtio-GPU FE (Frontend) driver in FIG. 4) and a corresponding virtio-GPU on the second virtual machine (virtio-GPU BE (Backend)) is performed through the shared memory 37. Using the virtio-GPU FE and BE drivers, the screencast receiver VM (second VM) emulates a virtual graphics card device for the screen sender VM (first VM). Instead of a network socket for video transfer, a virtual GPU device node is provided for the application. Thus, the graphics output may be provided to the second virtual machine 39 using a virtio-based shared memory driver (virtio-shmem (shared memory) FE and Shmem FE driver in FIG. 4) executed by the first virtual machine. As the transmission through shared memory 37 has a low overhead, the graphics output can be transmitted in lossless form from the first VM 38 to the second VM 39. Thus, the graphics output may be provided to the second virtual machine in an uncompressed or lossless manner.

On the side of the second VM, the processing circuitry (of the apparatus 30b for the second VM) obtains (e.g., receives) the graphics output of the application via the inter-virtual machine shared memory mechanism and outputs the graphics output to a display associated with the second virtual machine. Again, virtio-based drivers may be used for this purpose. For example, the graphics output may be obtained from the first virtual machine using a virtio-based shared memory driver (Shmem BE driver and virtio-shmem BE in FIG. 4) executed by the second virtual machine and using a virtio-based graphics processing unit driver (virtio-GPU BE) executed by the second virtual machine.

The second VM 38 may then use, in some examples, the iGPU 34 of the computer system 300 (or of another computer system associated with the display) to output the graphics output to the display 301. For example, the graphics output may be provided to the display 301 via an integrated graphics processing unit associated with the second virtual machine (which may be part of the computer system 300 or separate from the computer system 300). In some examples, e.g., to leverage the input signal-forwarding capabilities of screencasting, the graphics output may be output via a screencast client application executed by the second VM 39. Thus, the processing circuitry 32 (of the apparatus 30b for the second VM 39) may provide the graphics output to a screencast client application executed by the second virtual machine, with the screencast client application outputting the graphics output to the display.

In the proposed concept, the performance of the graphics rendering can be improved by using the discrete GPU, which may be used exclusively by the first VM 38 (and not by the second VM 39, for example). Thus, the processing circuitry 32 of the apparatus 30a for the first VM 38 may render the graphics output of the application using the discrete graphics processing unit 33 associated with the first virtual machine. Accordingly, the method for the first virtual machine may comprise rendering 350 the graphics output of the application using the discrete graphics processing unit associated with the first virtual machine. As outlined above, the first virtual machine may have dedicated and/or exclusive access to the discrete graphics processing unit.

The proposed concept is highly beneficial in case the application is a game that is played by a player, e.g., a player on the back seat of a car. Games are interactive pieces of software that are controlled by the player. Therefore, an input signal from an input device 302 (such as a gamepad or game controller, a keyboard, a mouse, a trackpad, or a touchscreen) may be routed through the second virtual machine (which is being controlled by the input device) to the first virtual machine (where the application is executed). Thus, the processing circuitry 32 (of the apparatus 30b for the second VM 39) may obtain an input signal of a user from an input device 302 associated with the second virtual machine 39, and provide a control signal for controlling the application to the first virtual machine. Accordingly, the method for the second VM 39 may comprise obtaining 330 the input signal of the user from the input device associated with the second virtual machine, and providing 335 the control signal for controlling the application to the first virtual machine. On the side of the first VM 38, the processing circuitry 32 (of the apparatus 30a for the first VM 39) may obtain the control signal for controlling the application from the second virtual machine, and provide the control signal to the application. Accordingly, the method for the first VM 38 further may comprise obtaining 340 the control signal for controlling the application from the second virtual machine, and providing 345 the control signal to the application. For example, the control signal may be provided/obtained between the VMs via a virtual network provided by the hypervisor 36 of the computer system 300 hosting the first virtual machine and the second virtual machine.

For example, the interface circuitry 31 or means for communicating 31 corresponds to one or more inputs and/or outputs designed to receive and/or transmit information. This information can be in digital (bit) values according to a specified code, whether exchanged within a module, between different modules, or even between modules of distinct entities. For example, the interface circuitry 31 or means for communicating 31 may include interface circuitry configured to handle the reception and/or transmission of such information.

For example, the processing circuitry 32 or means for processing 32 can be implemented using one or more processing units, processing devices, or any means for processing, such as a processor, a computer, or a programmable hardware component equipped with appropriately adapted software. Thus, the described function of the processing circuitry 32 or means for processing 32 can be executed in software, running on one or more programmable hardware components. Such components may include a general-purpose processor, a Digital Signal Processor (DSP), a microcontroller, or more.

For example, the discrete GPU circuitry 33 or discrete GPU 33 may correspond to a dedicated graphics processing unit that operates independently of the main processor. The discrete GPU 33 may include its own dedicated memory and power regulation systems, allowing for enhanced performance in graphics-intensive applications, machine learning tasks, and scientific computations.

For example, the integrated GPU circuitry 34 or integrated GPU 34 refers to a graphics processing unit that is built into the same die or package as the central processing unit. This component shares system memory with the CPU and is designed to provide basic to moderate graphics processing capabilities while consuming less power than discrete alternatives.

For example, the memory/storage circuitry 35 or means for storing information 35 may comprise at least one element of the group of a computer readable storage medium, such as a magnetic or optical storage medium, e.g., a hard disk drive, a flash memory, floppy disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the hypervisor 36 represents software, firmware, or hardware that creates and manages virtual machines. This component operates at a level between the hardware and the operating system, allowing multiple operating systems to run concurrently on a single physical machine. The hypervisor 36 is responsible for allocating physical resources, maintaining isolation between virtual machines, and providing virtual devices to guest operating systems.

For example, the shared memory 37 constitutes a region of memory that can be accessed by multiple processes, programs, or hardware components, in particular the first VM 38 and the second VM 39. This memory area enables efficient data exchange between different system elements without requiring complete data duplication. The shared memory 37 may be implemented using various technologies and protocols, such as virtio-shmem, to ensure proper synchronization and data integrity when accessed by multiple entities simultaneously.

For example, the first virtual machine 38 and second virtual machine 39 may represent software implementations of a computer that executes programs like a physical machine. This respective virtualized environment may include its own operating system, applications, and allocated resources while being isolated from other virtual machines on the same host.

More details and aspects of the computer system 300, apparatuses 30a, 30b, devices 30a, 30b, methods, and computer programs are mentioned in connection with the proposed concept or one or more examples described above or below (e.g., FIGS. 1 to 2, 4 to 8). The computer system 300, apparatuses 30a, 30b, devices 30a, 30b, methods, and computer programs may comprise one or more additional optional features corresponding to one or more aspects of the proposed concept or one or more examples described above or below.

Various examples of the proposed concept, shown in FIG. 4, use Inter-VM Shared Memory (ivshmem) as a shared memory mechanism. Inter-VM Shared Memory (ivshmem) is an industry-defined standard of shared memory mechanism between multiple virtual machines (VMs) running on the same host. It allows for fast, direct data exchange between VMs, bypassing the need for network communication.

The shared memory region may be exposed to the VMs as a PCI device. Each VM can map this region into its own address space, allowing for direct read and write access. This can be particularly useful in scenarios where VMs need to share large amounts of data quickly, such as in high-performance computing or real-time applications. Furthermore, it also provides a doorbell mechanism for notification between VMs.

The typical screencast case is screencasting an Android application from IVI-VM 39 (the first VM) to a Copilot-VM/Rear seat-VM 38 (the second VM), as shown in FIG. 4. FIG. 4 shows a detailed example of a computer system with two virtual machines. In FIG. 4, the data flow of dGPU rendering is shown, from a graphics block in the dGPU 33 to a dGPU driver in the IVI-VM 38, to an Operating System (OS) render stack of IVI-VM 38 to the application. From the application, the flow of the virtual display is shown, via an OS display stack, the Linux DRM (Digital Rights Management) framework, virtio-GPU FE driver, virtio-shmem FE, Shmem-FE driver (ivshmem) (all of IVI-VM 38), an ivshmem device provided by hypervisor 36 for IVI-VM 38, shared memory 37 and a notification, a second ivshmem device provided by hypervisor 36 for Copilot-VM/Rear seat-VM 39, a Shmem BE-driver (ivshmem), virtio-shmem BE and virtio-GPU BE to a screencast client app (all within the Copilot-VM/Rear seat-VM 39). From the screencast client app, a data flow to the local display is shown, via the OS display stack of the Copilot-VM/Rear seat-VM 39, an iGPU driver of the Copilot-VM/Rear seat-VM 39, and the iGPU 34 associated with the Copilot-VM/Rear seat-VM 39. In FIG. 4, the components modified/added compared to a network-based screencasting approach are highlighted with a thick dotted contour.

In summary, the following components may be provided or modified. In the hypervisor 36, a virtualized shared memory device 37 may be exposed to the Copilot-VM/Rear seat-VM 39 and the IVI-VM 38. In the Copilot-VM/Rear seat-VM 39, the virtio-shmem driver may be implemented to expose the shared memory and notification interface to user space. In the Copilot-VM/Rear seat-VM 39, the existing virtio-GPU backend service may be ported to a virtio-shmem-based user space interface to ensure it can expose related virtio-GPU spec-defined resources over the shared memory and notification mechanism. In the Copilot-VM/Rear seat-VM 39, the socket streaming logic of the existing screencast client may be modified to a DMAbuf (a Linux kernel API that allows for efficient sharing of memory buffers between different devices or subsystems, primarily used for zero-copy operations in graphics and multimedia processing)-based mechanism that can obtain the IVI-VM-exposed video frame over the framebuffer directly. In the IVI-VM 38, the virtio-GPU FE driver may be modified to support a virtual shmem-based transport layer instead of traditional (Memory-Mapped Input/Output), PCI (Peripheral Component Interconnect)-based transport layers. In the IVI-VM 38, the Android surfaceflinger may be modified to support switching the display from a dGPU display to a virtio-GPU display for the screencast use case. All other software components may be re-used directly, including the Linux DRM stack, Android framework, 3rd party Android applications, etc.

To validate the proposed concept, the quality of the transmission as well as the latency was evaluated. Network-based screencasting usually uses H264 or H265 (video compression standards) to encode and decode the display buffer. H264 or H265 provide lossy compression, which can sacrifice video quality. When the network is not good, the encoding bit rate may be lowered due to the flow control mechanism, and the video quality becomes even worse. In contrast, according to the proposed concept, the quality of triple-A games using lossless video quality screencast is lossless, regardless of the network status.

PSNR was used to quantify the difference before and after screencasting. Peak signal-to-noise ratio (PSNR) is the ratio between the maximum possible power of an image and the power of corrupting noise that affects the quality of its representation. In the network-based screencast, the PSNR was 28.36, compared to 361.2 (+1173.62%) using the proposed lossless screencast. Moreover, the network-based screencast uses more than 15 Megabits/s (at 1080p, 60 FPS), compared to 0 for the proposed concept.

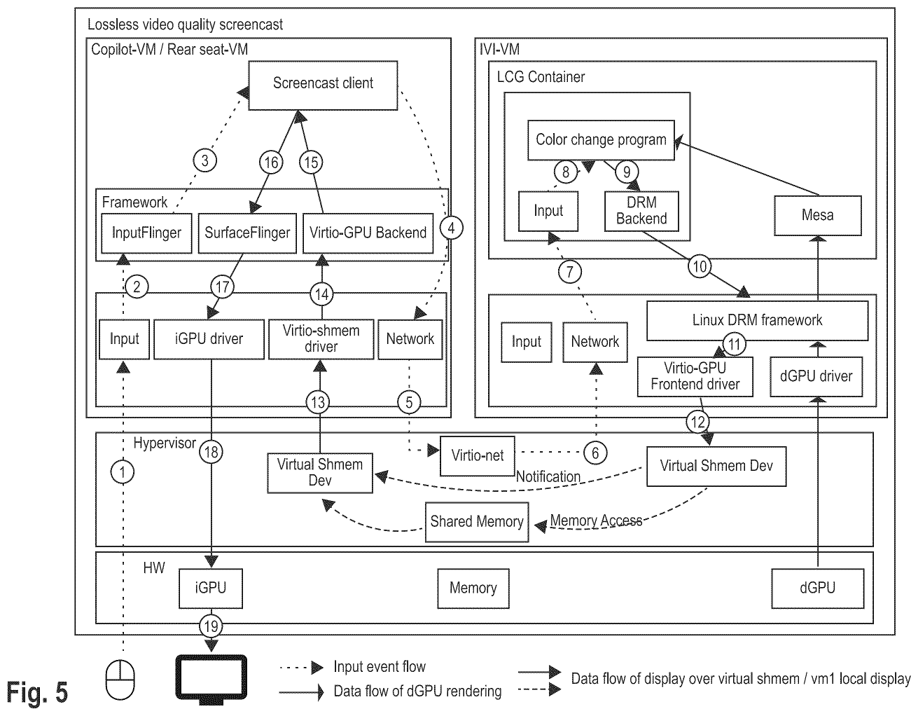

With respect to latency, a screencast 3A game was run in a Linux container on top of Android from IVI-VM 38 to Copilot-VM/Rear seat-VM 39 (see FIG. 5). As host software, Android 12L was used, and as the Linux container, Weston 10.0.92. FIG. 5 shows an input event flow, a data flow of the display over a virtual shmem/vm1 local display, and a data flow of dGPU rendering. To perform the latency test, an LED is connected to the left button of the mouse. When the left button is pressed down, the LED emits light. When the left button is lifted, the LED light turns off. The lift event is passed to the Linux Container. After receiving it, the color changing program changes the screen color. The changed screen color is sent to the physical display screen through rendering, transmission, and other operations. A high-speed camera (1000 FPS) is used to record the entire process of the LED and physical screen changing color. The latency is measured multiple times, and the average is calculated. The network-based screencast resulted in an end-to-end latency of more than 110 ms, compared to 98.3 milliseconds (−11.8%) for the lossless video quality screencast. It is to be noted that the network-based screencast is sensitive to the CPU load, while the lossless video quality screencast is not.

More details and aspects of the lossless video quality screencast mechanism are mentioned in connection with the proposed concept or one or more examples described above or below (e.g., FIGS. 1 to 3b, 6 to 8). The lossless video quality screencast mechanism may comprise one or more additional optional features corresponding to one or more aspects of the proposed concept or one or more examples described above or below.

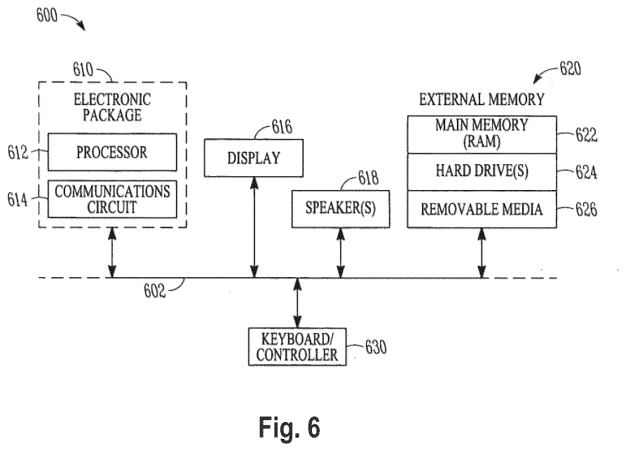

FIG. 6 shows a block diagram of an electronic apparatus 600 incorporating at least one electronic assembly and/or method described herein. Electronic apparatus 600 is merely one example of an electronic apparatus in which forms of the electronic assemblies and/or methods described herein may be used. Examples of an electronic apparatus 600 include, but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communication links among the various components of the electronic apparatus 600 and may be implemented as a single bus, as a combination of buses, or in any other suitable manner.

An electronic assembly 610 as described herein may be coupled to system bus 602. The electronic assembly 610 may include any circuit or combination of circuits. In one example, the electronic assembly 610 includes a processor 612 which can be of any type. As used herein, “processor” means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), a multi-core processor, or any other type of processor or processing circuit.

Other types of circuits that may be included in electronic assembly 610 are a custom circuit, an application-specific integrated circuit (ASIC), or the like, such as, for example, one or more circuits (such as a communications circuit 614) for use in wireless devices such as mobile telephones, tablet computers, laptop computers, two-way radios, and similar electronic systems. The IC can perform any other type of function.

The electronic apparatus 600 may also include an external memory 620, which in turn may include one or more memory elements suitable for the particular application, such as a main memory 622 in the form of random access memory (RAM), one or more hard drives 624, and/or one or more drives that handle removable media 626 such as compact disks (CDs), flash memory cards, digital video disks (DVDs), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

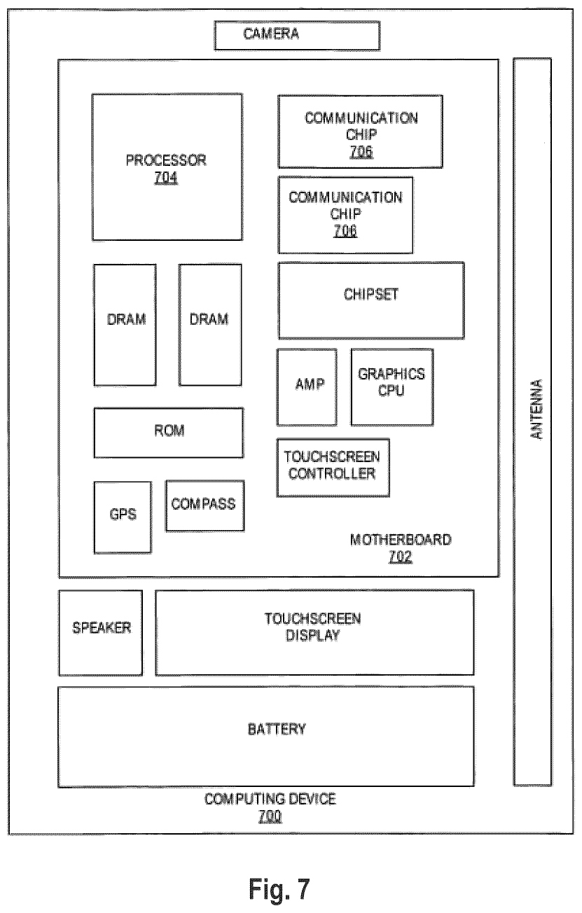

FIG. 7 illustrates a computing device 700 in accordance with one implementation of the proposed concept. The computing device 700 houses a board 702. The board 702 may include a number of components, including but not limited to a processor 704 and at least one communication chip 706. The processor 704 is physically and electrically coupled to the board 702. In some implementations, the at least one communication chip 706 is also physically and electrically coupled to the board 702. In further implementations, the communication chip 706 is part of the processor 704. Depending on its applications, the computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as a hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some examples they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth, and a second communication chip 706 may be dedicated to longer range wireless communications such as GPS, EDGE, GPRS, CDMA, WIMAX, LTE, Ev-DO, and others. The processor 704 of the computing device 700 includes an integrated circuit die packaged within the processor 704. In some implementations of the proposed concept, the integrated circuit die of the processor includes one or more devices that are assembled in an ePLB or eWLB based POP package that includes a mold layer directly contacting a substrate, in accordance with implementations of the proposed concept. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the proposed concept, the integrated circuit die of the communication chip includes one or more devices that are assembled in an ePLB or eWLB based POP package that includes a mold layer directly contacting a substrate, in accordance with implementations of the proposed concept.

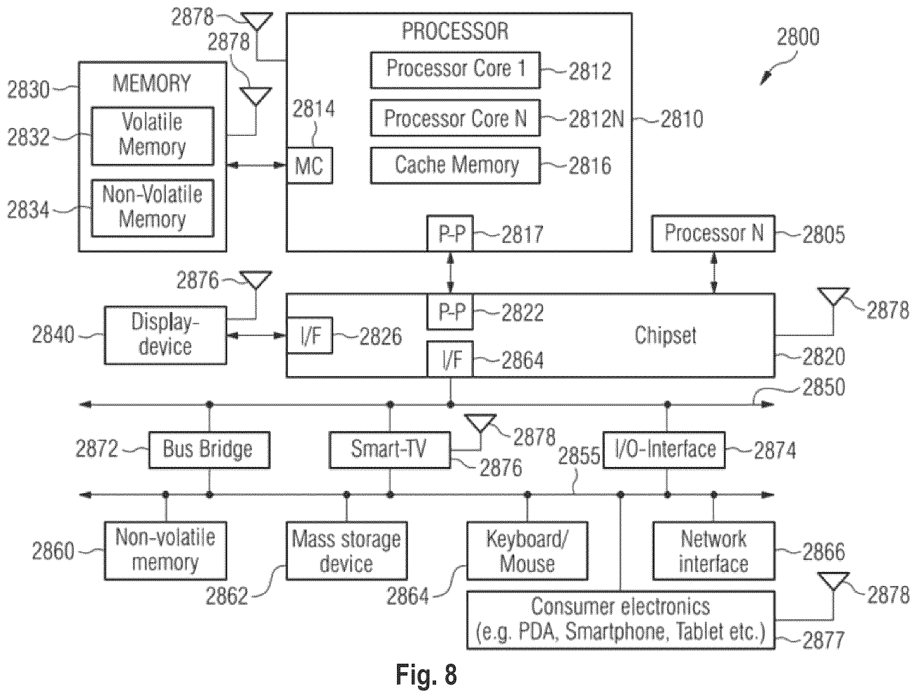

FIG. 8 is included to show an example of a higher-level device application for the disclosed examples. In an example, a computing system 2800 includes, but is not limited to, a desktop computer. In an example, a system 2800 includes, but is not limited to, a laptop computer. In an example, a system 2800 includes, but is not limited to, a netbook. In an example, a system 2800 includes, but is not limited to, a tablet. In an example, a system 2800 includes, but is not limited to, a notebook computer. In an example, a system 2800 includes, but is not limited to, a personal digital assistant (PDA). In an example, a system 2800 includes, but is not limited to, a server. In an example, a system 2800 includes, but is not limited to, a workstation. In an example, a system 2800 includes, but is not limited to, a cellular telephone. In an example, a system 2800 includes, but is not limited to, a mobile computing device. In an example, a system 2800 includes, but is not limited to, a smartphone. In an example, a system 2800 includes, but is not limited to, an internet appliance. Other types of computing devices may be configured with the microelectronic device that includes apparatus or device examples.

In an example, the processor 2810 has one or more processing cores 2812 and 2812N, where 2812N represents the Nth processor core inside processor 2810, and N is a positive integer. In an example, the electronic device system 2800 uses an example of an apparatus, device, or computer system that includes multiple processors including 2810 and 2805, where the processor 2805 has logic similar to or identical to the logic of the processor 2810. In an example, the processing core 2812 includes, but is not limited to, pre-fetch logic to fetch instructions, decode logic to decode the instructions, execution logic to execute instructions, and the like. In an example, the processor 2810 has a cache memory 2816 to cache at least one of instructions and data for the apparatus or device in the system 2800. The cache memory 2816 may be organized into a hierarchical structure including one or more levels of cache memory.

In an example, the processor 2810 includes a memory controller 2814, which is operable to perform functions that enable the processor 2810 to access and communicate with memory 2830 that includes at least one of a volatile memory 2832 and a non-volatile memory 2834. In an example, the processor 2810 is coupled with memory 2830 and chipset 2820. The processor 2810 may also be coupled to a wireless antenna 2878 to communicate with any device configured to at least one of transmit and receive wireless signals. In an example, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an example, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an example, the memory 2830 may also store temporary variables or other intermediate information while the processor 2810 is executing instructions. In the illustrated example, the chipset 2820 connects with the processor 2810 via Point-to-Point (PtP or P-P) interfaces 2817 and 2822. Either of these PtP examples may be achieved using an apparatus, device, or computer system as set forth in this disclosure. The chipset 2820 enables the processor 2810 to connect to other elements in the apparatus or device within a system 2800. In an example, interfaces 2817 and 2822 operate in accordance with a PtP communication protocol, such as the Intel® QuickPath Interconnect (QPI) or the like. In other examples, a different interconnect may be used.

In an example, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least transmit or receive wireless signals.

The chipset 2820 connects to the display device 2840 via the interface 2826. The display 2840 may be, for example, a liquid crystal display (LCD), a plasma display, a cathode ray tube (CRT) display, or any other form of visual display device. In an example, the processor 2810 and the chipset 2820 are merged into an apparatus or device within a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872, such as at least one apparatus or device. In an example, the chipset 2820 couples with a non-volatile memory 2860, a mass storage device(s) 2862, a keyboard/mouse 2864, and a network interface 2866 by way of at least one of the interfaces 2824 and 2874, the smart TV 2876, and the consumer electronics 2877, etc.

In an example, the mass storage device 2862 includes, but is not limited to, a solid-state drive, a hard disk drive, a universal serial bus flash memory drive, or any other form of computer data storage medium. In one example, the network interface 2866 is implemented by any type of well-known network interface standard, including, but not limited to, an Ethernet interface, a universal serial bus (USB) interface, a Peripheral Component Interconnect (PCI) Express interface, a wireless interface, and/or any other suitable type of interface. In one example, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 8 are depicted as separate blocks within the apparatus or device in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects thereof) may be incorporated into the processor core 2812.

Where useful, the computing system 2800 may have a broadcasting structure interface, such as for attaching the apparatus or device to a cellular tower.

In the following, some examples of the proposed concept are presented:

An example (e.g., example 1) relates to a non-transitory computer-readable medium storing instructions that, when executed by one or more processing circuitries, cause the one or more processing circuitries to perform a method for a first virtual machine, comprising executing an application, providing a virtual screen for a graphics output of the application, providing the graphics output provided to the virtual screen to a second virtual machine via an inter-virtual machine shared memory mechanism.

Another example (e.g., example 2) relates to a previous example (e.g., example 1) or to any other example, further comprising that the method further comprises obtaining a control signal for controlling the application from the second virtual machine, and providing the control signal to the application.

Another example (e.g., example 3) relates to a previous example (e.g., example 2) or to any other example, further comprising that the control signal is obtained via a virtual network provided by a hypervisor of a computer system hosting the first virtual machine and the second virtual machine.

Another example (e.g., example 4) relates to a previous example (e.g., one of the examples 1 to 3) or to any other example, further comprising that the virtual display is provided by a virtio-based graphics processing unit driver executed by the first virtual machine, and the graphics output is provided to the second virtual machine using a virtio-based shared memory driver executed by the first virtual machine.

Another example (e.g., example 5) relates to a previous example (e.g., one of the examples 1 to 4) or to any other example, further comprising that the method comprises rendering the graphics output of the application using a discrete graphics processing unit associated with the first virtual machine.

Another example (e.g., example 6) relates to a previous example (e.g., example 5) or to any other example, further comprising that the first virtual machine has dedicated and/or exclusive access to the discrete graphics processing unit.

Another example (e.g., example 7) relates to a previous example (e.g., one of the examples 1 to 6) or to any other example, further comprising that the graphics output is provided to the second virtual machine in an uncompressed or lossless manner.

Another example (e.g., example 8) relates to a previous example (e.g., one of the examples 1 to 7) or to any other example, further comprising that the application is executed within a container running within the first virtual machine.

Another example (e.g., example 9) relates to a previous example (e.g., one of the examples 1 to 8) or to any other example, further comprising that the graphics output is provided to a shared memory device provided by a hypervisor of a computer system hosting the first virtual machine and the second virtual machine.

An example (e.g., example 10) relates to a non-transitory computer-readable medium storing instructions that, when executed by one or more processing circuitries, cause the one or more processing circuitries to perform a method for a second virtual machine, comprising obtaining a graphics output of an application being executed by a first virtual machine via an inter-virtual machine shared memory mechanism, and outputting the graphics output to a display associated with the second virtual machine.

Another example (e.g., example 11) relates to a previous example (e.g., example 10) or to any other example, further comprising that the method comprises obtaining an input signal of a user from an input device associated with the second virtual machine, and providing a control signal for controlling the application to the first virtual machine.

Another example (e.g., example 12) relates to a previous example (e.g., example 11) or to any other example, further comprising that the control signal is provided via a virtual network provided by a hypervisor of a computer system hosting the first virtual machine and the second virtual machine.

Another example (e.g., example 13) relates to a previous example (e.g., one of the examples 10 to 12) or to any other example, further comprising that the graphics output is obtained from the first virtual machine using a virtio-based shared memory driver executed by the second virtual machine and using a virtio-based graphics processing unit driver executed by the second virtual machine.

Another example (e.g., example 14) relates to a previous example (e.g., one of the examples 10 to 13) or to any other example, further comprising that the graphics output is provided to a display via an integrated graphics processing unit associated with the second virtual machine.

Another example (e.g., example 15) relates to a previous example (e.g., one of the examples 10 to 14) or to any other example, further comprising that the method comprises providing the graphics output to a screencast client application executed by the second virtual machine, with the screencast client application outputting the graphics output to the display.

An example (e.g., example 16) relates to a method for a first virtual machine, comprising executing (310) an application, providing (320) a virtual screen for a graphics output of the application, providing (360) the graphics output provided to the virtual screen to a second virtual machine via an inter-virtual machine shared memory mechanism.

Another example (e.g., example 17) relates to a previous example (e.g., example 16) or to any other example, further comprising that the method further comprises obtaining (340) a control signal for controlling the application from the second virtual machine, and providing (345) the control signal to the application.

Another example (e.g., example 18) relates to a previous example (e.g., example 17) or to any other example, further comprising that the control signal is obtained via a virtual network provided by a hypervisor of a computer system hosting the first virtual machine and the second virtual machine.

Another example (e.g., example 19) relates to a previous example (e.g., one of the examples 16 to 18) or to any other example, further comprising that the virtual display is provided by a virtio-based graphics processing unit driver executed by the first virtual machine, and the graphics output is provided to the second virtual machine using a virtio-based shared memory driver executed by the first virtual machine.

Another example (e.g., example 20) relates to a previous example (e.g., one of the examples 16 to 19) or to any other example, further comprising that the method comprises rendering (350) the graphics output of the application using a discrete graphics processing unit associated with the first virtual machine.

Another example (e.g., example 21) relates to a previous example (e.g., example 20) or to any other example, further comprising that the first virtual machine has dedicated and/or exclusive access to the discrete graphics processing unit.

Another example (e.g., example 22) relates to a previous example (e.g., one of the examples 16 to 21) or to any other example, further comprising that the graphics output is provided to the second virtual machine in an uncompressed or lossless manner.

Another example (e.g., example 23) relates to a previous example (e.g., one of the examples 16 to 22) or to any other example, further comprising that the application is executed within a container running within the first virtual machine.

Another example (e.g., example 24) relates to a previous example (e.g., one of the examples 16 to 23) or to any other example, further comprising that the graphics output is provided to a shared memory device provided by a hypervisor of a computer system hosting the first virtual machine and the second virtual machine.

An example (e.g., example 25) relates to a method for a second virtual machine, comprising obtaining (370) a graphics output of an application being executed by a first virtual machine via an inter-virtual machine shared memory mechanism, and outputting (380) the graphics output to a display associated with the second virtual machine.

Another example (e.g., example 26) relates to a previous example (e.g., example 25) or to any other example, further comprising that the method comprises obtaining (330) an input signal of a user from an input device associated with the second virtual machine, and providing (335) a control signal for controlling the application to the first virtual machine.

Another example (e.g., example 27) relates to a previous example (e.g., example 26) or to any other example, further comprising that the control signal is provided via a virtual network provided by a hypervisor of a computer system hosting the first virtual machine and the second virtual machine.

Another example (e.g., example 28) relates to a previous example (e.g., one of the examples 25 to 27) or to any other example, further comprising that the graphics output is obtained from the first virtual machine using a virtio-based shared memory driver executed by the second virtual machine and using a virtio-based graphics processing unit driver executed by the second virtual machine.

Another example (e.g., example 29) relates to a previous example (e.g., one of the examples 25 to 28) or to any other example, further comprising that the graphics output is provided to a display via an integrated graphics processing unit associated with the second virtual machine.

Another example (e.g., example 30) relates to a previous example (e.g., one of the examples 25 to 29) or to any other example, further comprising that the method comprises providing the graphics output to a screencast client application executed by the second virtual machine, with the screencast client application outputting the graphics output to the display.

An example (e.g., example 31) relates to an apparatus for providing a first virtual machine, comprising interface circuitry, machine-readable instructions, and processing circuitry to execute the machine-readable instructions to execute an application, provide a virtual screen for a graphics output of the application, provide the graphics output provided to the virtual screen to a second virtual machine via an inter-virtual machine shared memory mechanism.

Another example (e.g., example 32) relates to a previous example (e.g., example 31) or to any other example, further comprising that the processing circuitry is to execute the machine-readable instructions to obtain a control signal for controlling the application from the second virtual machine, and provide the control signal to the application.

Another example (e.g., example 33) relates to a previous example (e.g., example 32) or to any other example, further comprising that the control signal is obtained via a virtual network provided by a hypervisor of a computer system hosting the first virtual machine and the second virtual machine.

Another example (e.g., example 34) relates to a previous example (e.g., one of the examples 31 to 33) or to any other example, further comprising that the virtual display is provided by a virtio-based graphics processing unit driver executed by the first virtual machine, and the graphics output is provided to the second virtual machine using a virtio-based shared memory driver executed by the first virtual machine.

Another example (e.g., example 35) relates to a previous example (e.g., one of the examples 31 to 34) or to any other example, further comprising that the processing circuitry is to execute the machine-readable instructions to render the graphics output of the application using a discrete graphics processing unit associated with the first virtual machine.

Another example (e.g., example 36) relates to a previous example (e.g., example 35) or to any other example, further comprising that the first virtual machine has dedicated and/or exclusive access to the discrete graphics processing unit.

Another example (e.g., example 37) relates to a previous example (e.g., one of the examples 31 to 36) or to any other example, further comprising that the graphics output is provided to the second virtual machine in an uncompressed or lossless manner.

Another example (e.g., example 38) relates to a previous example (e.g., one of the examples 31 to 37) or to any other example, further comprising that the application is executed within a container running within the first virtual machine.

Another example (e.g., example 39) relates to a previous example (e.g., one of the examples 31 to 38) or to any other example, further comprising that the graphics output is provided to a shared memory device provided by a hypervisor of a computer system hosting the first virtual machine and the second virtual machine.

An example (e.g., example 40) relates to an apparatus for providing a second virtual machine, comprising interface circuitry, machine-readable instructions, and processing circuitry to execute the machine-readable instructions to obtain a graphics output of an application being executed by a first virtual machine via an inter-virtual machine shared memory mechanism, and output the graphics output to a display associated with the second virtual machine.

Another example (e.g., example 41) relates to a previous example (e.g., example 40) or to any other example, further comprising that the processing circuitry is to execute the machine-readable instructions to obtain an input signal of a user from an input device associated with the second virtual machine, and provide a control signal for controlling the application to the first virtual machine.

Another example (e.g., example 42) relates to a previous example (e.g., example 41) or to any other example, further comprising that the control signal is provided via a virtual network provided by a hypervisor of a computer system hosting the first virtual machine and the second virtual machine.

Another example (e.g., example 43) relates to a previous example (e.g., one of the examples 40 to 42) or to any other example, further comprising that the graphics output is obtained from the first virtual machine using a virtio-based shared memory driver executed by the second virtual machine and using a virtio-based graphics processing unit driver executed by the second virtual machine.

Another example (e.g., example 44) relates to a previous example (e.g., one of the examples 40 to 43) or to any other example, further comprising that the graphics output is provided to a display via an integrated graphics processing unit associated with the second virtual machine.

Another example (e.g., example 45) relates to a previous example (e.g., one of the examples 40 to 44) or to any other example, further comprising that the processing circuitry is to execute the machine-readable instructions to provide the graphics output to a screencast client application executed by the second virtual machine, with the screencast client application outputting the graphics output to the display.

An example (e.g., example 46) relates to a device for providing a first virtual machine, comprising means for processing configured to execute an application, provide a virtual screen for a graphics output of the application, provide the graphics output provided to the virtual screen to a second virtual machine via an inter-virtual machine shared memory mechanism.

Another example (e.g., example 47) relates to a previous example (e.g., example 46) or to any other example, further comprising that the means for processing is configured to obtain a control signal for controlling the application from the second virtual machine, and provide the control signal to the application.

Another example (e.g., example 48) relates to a previous example (e.g., example 47) or to any other example, further comprising that the control signal is obtained via a virtual network provided by a hypervisor of a computer system hosting the first virtual machine and the second virtual machine.

Another example (e.g., example 49) relates to a previous example (e.g., one of the examples 46 to 48) or to any other example, further comprising that the virtual display is provided by a virtio-based graphics processing unit driver executed by the first virtual machine, and the graphics output is provided to the second virtual machine using a virtio-based shared memory driver executed by the first virtual machine.

Another example (e.g., example 50) relates to a previous example (e.g., one of the examples 46 to 49) or to any other example, further comprising that the means for processing is configured to render the graphics output of the application using a discrete graphics processing unit associated with the first virtual machine.

Another example (e.g., example 51) relates to a previous example (e.g., example 50) or to any other example, further comprising that the first virtual machine has dedicated and/or exclusive access to the discrete graphics processing unit.

Another example (e.g., example 52) relates to a previous example (e.g., one of the examples 46 to 51) or to any other example, further comprising that the graphics output is provided to the second virtual machine in an uncompressed or lossless manner.

Another example (e.g., example 53) relates to a previous example (e.g., one of the examples 46 to 52) or to any other example, further comprising that the application is executed within a container running within the first virtual machine.

Another example (e.g., example 54) relates to a previous example (e.g., one of the examples 46 to 53) or to any other example, further comprising that the graphics output is provided to a shared memory device provided by a hypervisor of a computer system hosting the first virtual machine and the second virtual machine.

An example (e.g., example 55) relates to a device for providing a second virtual machine, comprising means for processing configured to obtain a graphics output of an application being executed by a first virtual machine via an inter-virtual machine shared memory mechanism, and output the graphics output to a display associated with the second virtual machine.

Another example (e.g., example 56) relates to a previous example (e.g., example 55) or to any other example, further comprising that the means for processing is configured to obtain an input signal of a user from an input device associated with the second virtual machine, and provide a control signal for controlling the application to the first virtual machine.

Another example (e.g., example 57) relates to a previous example (e.g., example 56) or to any other example, further comprising that the control signal is provided via a virtual network provided by a hypervisor of a computer system hosting the first virtual machine and the second virtual machine.

Another example (e.g., example 58) relates to a previous example (e.g., one of the examples 55 to 57) or to any other example, further comprising that the graphics output is obtained from the first virtual machine using a virtio-based shared memory driver executed by the second virtual machine and using a virtio-based graphics processing unit driver executed by the second virtual machine.

Another example (e.g., example 59) relates to a previous example (e.g., one of the examples 55 to 58) or to any other example, further comprising that the graphics output is provided to a display via an integrated graphics processing unit associated with the second virtual machine.

Another example (e.g., example 60) relates to a previous example (e.g., one of the examples 55 to 59) or to any other example, further comprising that the means for processing is configured to provide the graphics output to a screencast client application executed by the second virtual machine, with the screencast client application outputting the graphics output to the display.

Another example (e.g., example 61) relates to a computer system comprising an apparatus for providing a first virtual machine according to one of the examples 31 to 39 and an apparatus for providing a second virtual machine according to one of the examples 40 to 45.

Another example (e.g., example 62) relates to a computer system comprising a device for providing a first virtual machine according to one of the examples 46 to 54 and a device for providing a second virtual machine according to one of the examples 55 to 60.

Another example (e.g., example 63) relates to a previous example (e.g., one of the examples 61 or 62) or to any other example, further comprising a discrete graphics processing unit.

Another example (e.g., example 64) relates to a computer program having a program code for performing the method of one of the examples 16 to 24 and/or the method of one of the examples 25 to 30, when the computer program is executed on a computer, a processor, or a programmable hardware component.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products, as well as any data created and/or used during implementation of the disclosed technologies, can be stored on one or more tangible or non-transitory computer-readable storage media, such as volatile memory (e.g., DRAM, SRAM), non-volatile memory (e.g., flash memory, chalcogenide-based phase-change non-volatile memory), optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion thereof) may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions executed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, infrared, and ultrasonic communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed items. For example, the phrase “at least one of A, B or C” can mean A; B; C; A and B; A and C; B and C; or A, B, and C. Moreover, as used in this application and the claims, a list of items joined by the term “one or more of” can mean any combination of the listed items. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components.

Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory computer-readable medium storing instructions that, when executed by one or more processing circuitries, cause the one or more processing circuitries to perform a method for a first virtual machine, comprising:
executing an application;
providing a virtual screen for a graphics output of the application;
providing the graphics output provided to the virtual screen to a second virtual machine via an inter-virtual machine shared memory mechanism.

2. The non-transitory computer-readable medium according to claim 1, wherein the method further comprises obtaining a control signal for controlling the application from the second virtual machine, and providing the control signal to the application.

3. The non-transitory computer-readable medium according to claim 2, wherein the control signal is obtained via a virtual network provided by a hypervisor of a computer system hosting the first virtual machine and the second virtual machine.

4. The non-transitory computer-readable medium according to claim 1, wherein the virtual display is provided by a virtio-based graphics processing unit driver executed by the first virtual machine, and the graphics output is provided to the second virtual machine using a virtio-based shared memory driver executed by the first virtual machine.

5. The non-transitory computer-readable medium according to claim 1, wherein the method comprises rendering the graphics output of the application using a discrete graphics processing unit associated with the first virtual machine.

6. The non-transitory computer-readable medium according to claim 5, wherein the first virtual machine has dedicated and/or exclusive access to the discrete graphics processing unit.

7. The non-transitory computer-readable medium according to claim 1, wherein the graphics output is provided to the second virtual machine in an uncompressed or lossless manner.

8. The non-transitory computer-readable medium according to claim 1, wherein the application is executed within a container running within the first virtual machine.

9. The non-transitory computer-readable medium according to claim 1, wherein the graphics output is provided to a shared memory device provided by a hypervisor of a computer system hosting the first virtual machine and the second virtual machine.

10. A non-transitory computer-readable medium storing instructions that, when executed by one or more processing circuitries, cause the one or more processing circuitries to perform a method for a second virtual machine, comprising:
obtaining a graphics output of an application being executed by a first virtual machine via an inter-virtual machine shared memory mechanism; and
outputting the graphics output to a display associated with the second virtual machine.

11. The non-transitory computer-readable medium according to claim 10, wherein the method comprises obtaining an input signal of a user from an input device associated with the second virtual machine, and providing a control signal for controlling the application to the first virtual machine.

12. The non-transitory computer-readable medium according to claim 11, wherein the control signal is provided via a virtual network provided by a hypervisor of a computer system hosting the first virtual machine and the second virtual machine.

13. The non-transitory computer-readable medium according to claim 10, wherein the graphics output is obtained from the first virtual machine using a virtio-based shared memory driver executed by the second virtual machine and using a virtio-based graphics processing unit driver executed by the second virtual machine.

14. The non-transitory computer-readable medium according to claim 10, wherein the graphics output is provided to a display via an integrated graphics processing unit associated with the second virtual machine.

15. The non-transitory computer-readable medium according to claim 10, wherein the method comprises providing the graphics output to a screencast client application executed by the second virtual machine, with the screencast client application outputting the graphics output to the display.

16. An apparatus for providing a first virtual machine, comprising interface circuitry, machine-readable instructions, and processing circuitry to execute the machine-readable instructions to:
execute an application;
provide a virtual screen for a graphics output of the application;
provide the graphics output provided to the virtual screen to a second virtual machine via an inter-virtual machine shared memory mechanism.

17. The apparatus according to claim 16, wherein the processing circuitry is to execute the machine-readable instructions to obtain a control signal for controlling the application from the second virtual machine, and provide the control signal to the application.

18. The apparatus according to claim 17, wherein the control signal is obtained via a virtual network provided by a hypervisor of a computer system hosting the first virtual machine and the second virtual machine.

19. The apparatus according to claim 16, wherein the virtual display is provided by a virtio-based graphics processing unit driver executed by the first virtual machine, and the graphics output is provided to the second virtual machine using a virtio-based shared memory driver executed by the first virtual machine.

20. The apparatus according to claim 16, wherein the processing circuitry is to execute the machine-readable instructions to render the graphics output of the application using a discrete graphics processing unit associated with the first virtual machine.
